(19) United States
(12) Patent Application Publication
(10) Pub. No.: US 2010/0328237 A1
(43) Pub. Date: Dec. 30, 2010

(54) TOUCH CONTROL SYSTEM FOR CONTROLLING TOUCH PANEL

(76) Inventors: Yaw-Guang Chang, Tainan County (TW); Yi-Long Yang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/702,314

(22) Filed: Feb. 9, 2010

Related U.S. Application Data
(60) Provisional application No. 61/219,782, filed on Jun. 24, 2009.

(51) Int. Cl. G06F 3/041

(52) U.S. Cl. 345/173

(57) ABSTRACT

A touch control system for controlling a touch panel includes a controller and a first sensing circuit. The controller generates and outputs a control signal. The first sensing circuit is coupled to the control device and to sensing lines of the touch panel, and the first sensing circuit receives the control signal from the controller, and generates at least one scan control signal according to the received control signal to determine a scan timing setting.

### CROSS REFERENCE TO RELATED APPLICATIONS

This application claims the benefit of U.S. provisional application No. 61/219,782, which was filed on Jun. 24, 2009 and is included herein by reference.

### BACKGROUND OF THE INVENTION

1. Field of the Invention

The present invention relates to control of a touch panel, and more particularly, to an effective touch control system for controlling scan operations (sensing operations) of a touch panel with reduced hardware costs.

2. Description of the Prior Art

In the conventional technology of touch control systems, an additional micro controller is required when there is a need to make synchronous connections between a plurality of touch ICs for executing sensing operations of the touch panel. Please refer to FIG. 1. FIG. 1 is a diagram illustrating a conventional touch control system for controlling a touch panel according to the related art. The touch control system 100 has a micro controller 110, a first touch integrated circuit (touch IC) 120, a second touch IC 130 and a third touch IC 140. The micro controller 110 generates control signals S_{control} for controlling the operations of the touch ICs 120-140 and generates a vertical control signal V and a horizontal control signal H to the touch ICs 120-140 for controlling the scan operations (e.g., sensing operations for sensing the scan lines of the touch panel). That is, for the scan operations, the micro controller 110 serves as a master device for setting the scan timing and the length and controls the corresponding slave devices (touch ICs 120-140) for executing scan operations of the touch panel according to the set scan timing/scan length. The micro controller 110 synchronously processes the sensed data after the slave devices ICs 120-140 finish sensing the scan lines of the touch panel and transmit the sensed data to the micro controller 110. However, the required sensing synchronizing control is a burden for the micro controller 110 and the hardware costs are raised due to the required connecting ports.

Therefore, what is clearly needed is a control system that solves the problems of the conventional touch control system and upgrades the processing speed of the micro controller with reduced hardware cost.

### SUMMARY OF THE INVENTION

According to an exemplary embodiment of the present invention, a touch control system for controlling a touch panel is provided. The touch control system includes a controller and a first sensing circuit. The controller generates and outputs a control signal. The first sensing circuit is coupled to the control device and to sensing lines of the touch panel, and the first sensing circuit receives the control signal from the controller, and generates at least one scan control signal according to the received control signal to determine a scan timing setting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional touch control system controlling a touch panel according to the related art.

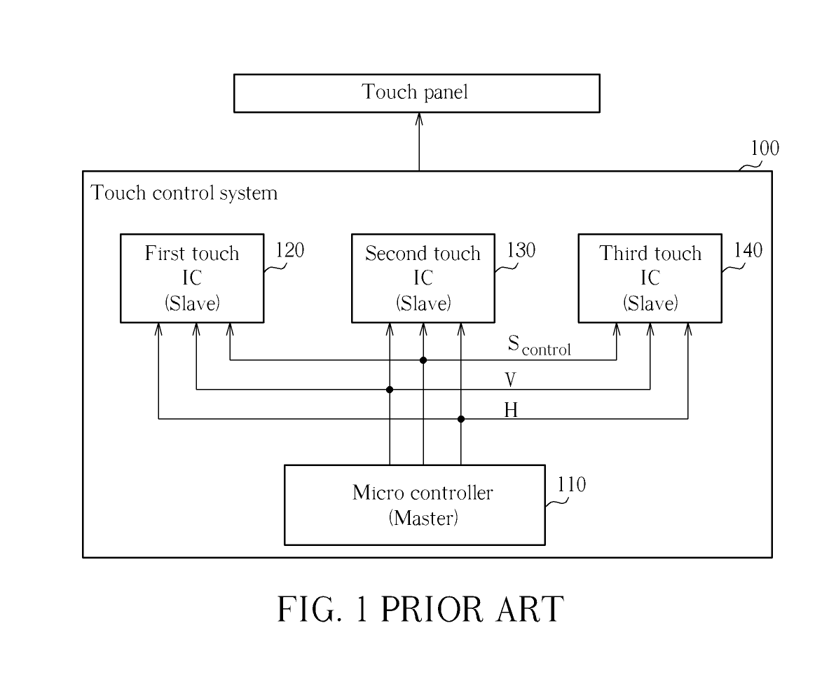

FIG. 2 is a diagram illustrating an exemplary embodiment of a touch control system of the present invention.

FIG. 3 is an exemplary embodiment of the touch control system in FIG. 2.

FIG. 4 is a diagram illustrating the vertical scan control signal S_{vertical}_{_{—}}_{scan} and the horizontal scan control signal S_{horizontal}_{_{—}}_{scan} generated via the first sensing circuit 320 shown in FIG. 3.

FIG. 5 is a diagram illustrating another exemplary embodiment of a touch control system of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

One of the main features of the present invention is providing a touch control system which sets one of the touch ICs as the transmitting terminal of sensing synchronization signals (e.g., scan control signals) via a programming manner, and sets the residue touch ICs as the receiving terminals of the sensing synchronization signals. In this way, the micro controller is no longer the master device which needs generating the scan control signals and therefore the required hardware ports between the micro controller and the touch ICs are reduced. In addition, the sensing timing is made programmable.

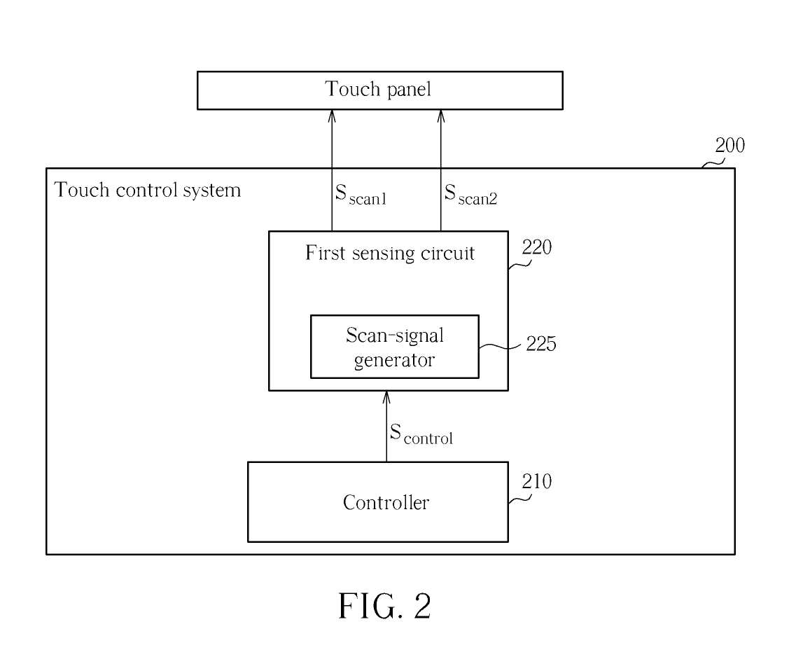

Please refer to FIG. 2. FIG. 2 is a diagram illustrating an exemplary embodiment of a touch control system of the present invention. The touch control system 200 has a controller 210 and a first sensing circuit 220. The controller 210 generates and outputs a control signal S_{control} to the first sensing circuit 220. The first sensing circuit 220 is coupled to the controller 210, and the sensing lines of the touch panel, and the first sensing circuit 220 generates scan control signals for controlling the scan operations of the touch panel and determining a scan timing setting according to the control signal S_{control}. For clarity, the first sensing circuit 220 sets the scan timing setting to scan/sense each sensing line of the touch panel. As the scan operation of the sensing lines of the touch panel is well known by people skilled in this art, further description is omitted here for the sake of brevity. In some embodiments of the present invention, the first sensing circuit 220 includes a scan-signal generator 225, where the scan-signal generator 225 generates a plurality of scan control signals (e.g., a first scan control signal S_{scan1} and a second scan control signal S_{scan2}) to determine the timing, as well as the length, of the vertical scan operations and of the horizontal scan operations corresponding to the sensing lines of the touch panel. The detailed descriptions of the scan timing setting and the scan control signals generated by the first sensing circuit 220 will be disclosed in the following.

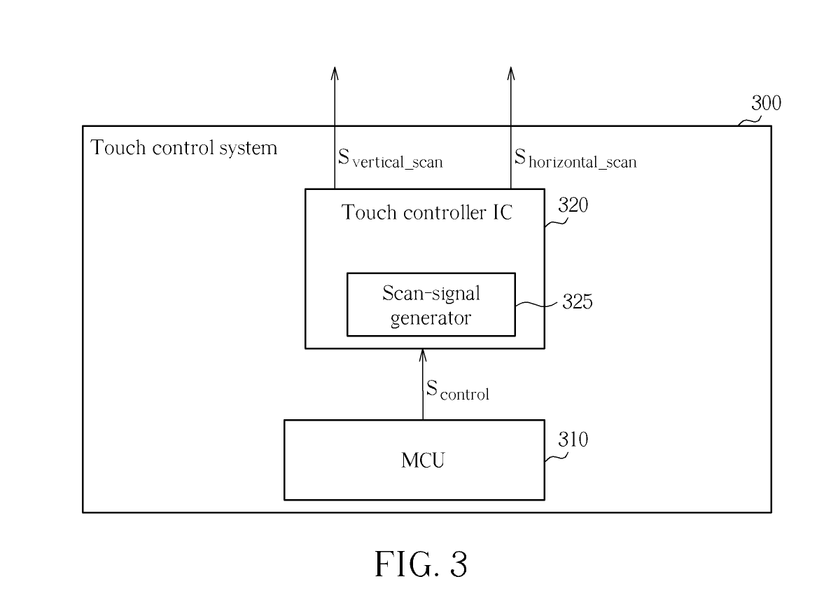

In some cases, the controller 210 can be a micro control unit (MCU) and the first sensing circuit 220 can be a touch controller integrated IC (touch controller IC). Apart from the conventional scheme, the touch controller IC can also generate the scan control signals by itself through the scan-signal generator 325. Please refer to FIG. 3. FIG. 3 is an exemplary embodiment of the touch control system in FIG. 2. The touch control system 300 has an MCU 310 serving as the controller 210, a touch controller IC 320 serving as the first sensing circuit 220, and a scan-signal generator 325 inside the touch controller IC for setting a vertical scan register and a horizontal scan register (not shown) to set the timing and the length of the first scan control signal S_{scan1} (e.g., herein the first scan control signal S_{scan1} can be a vertical scan control signal S_{vertical}_{_{—}}_{scan}) and of the second scan control signal S_{scan2} (in this exemplary embodiment, the second scan control signal S_{scan2} can be a horizontal scan control signal S_{horizontal}_{_{—}}_{scan}) respectively. That is, the vertical scan control signal S_{vertical}_{_{—}}_{scan} corresponds to a scan time setting which controls the required time for scanning a frame of a touch panel; while the horizontal scan control signal S_{horizontal}_{_{—}}_{scan} corresponds to a scan time setting which determines the required time for scanning a scan line of the touch panel. In addition, the touch controller IC 320 is the generating terminal of the scan control signals (e.g., the vertical scan control signal S_{vertical}_{_{—}}_{scan} and the horizontal scan control signal S_{horizontal}_{_{—}}_{scan}) and thereby the required ports between the MCU 310 and the touch controller IC 320 are reduced while the MCU 310 is aware of the timing and the length of the scan operations which is executed according to the scan control signals (S_{vertical}_{_{—}}_{scan} and S_{horizontal}_{_{—}}_{scan}) outputted from the touch controller IC 320. In short, the MCU 310 sets the scan-signal generator 325 within the touch controller IC 320 via the control signal S_{control}, wherein the scan-signal generator 325 can generate a plurality of vertical scan control signals and a plurality of horizontal scan control signals. In other words, by using the control signal S_{control}, the touch controller IC 320 can be used as the scan-signal generating terminal to set the sensing timing by itself. That is, once the touch control system has a single touch controller IC, the MCU acknowledges the sensing timing of the scan operations corresponding to the touch controller IC 320 via the vertical scan control signals S_{vertical}_{_{—}}_{scan} and the horizontal sensing signals S_{horizontal}_{_{—}}_{scan}.

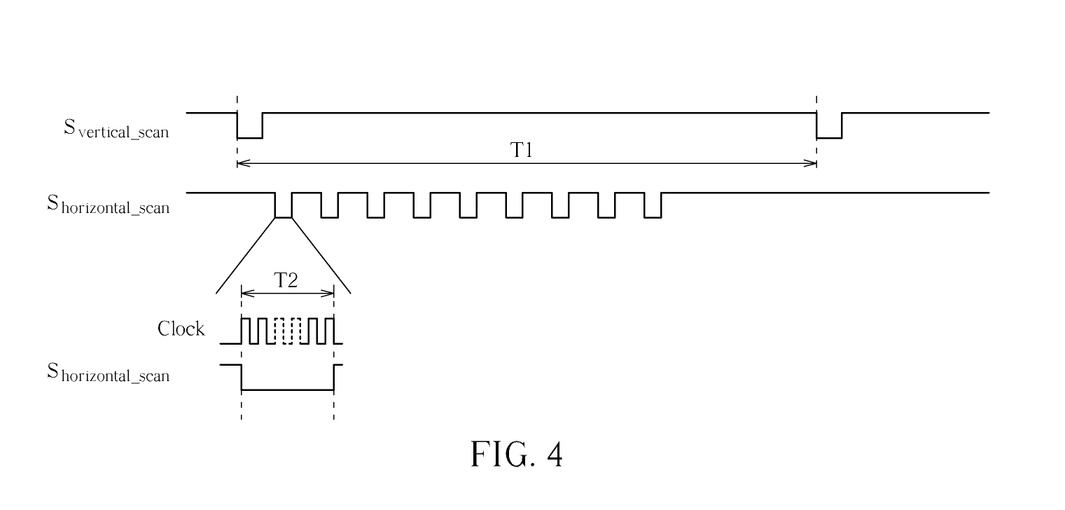

Please refer to FIG. 4 in conjunction with FIGS. 2˜3. FIG. 4 is a diagram illustrating the vertical scan control signal S_{vertical}_{_{—}}_{scan} and the horizontal scan control signal S_{horizontal}_{_{—}}_{scan} generated by the first sensing circuit 320 shown in FIG. 3. In this illustrated example, supposing that the time length of the vertical scan control signal S_{vertical}_{_{—}}_{scan} is T1 and the time length of the horizontal scan control signal S_{horizontal}_{_{—}}_{scan} is T2, this means the time length required for sensing a frame of the corresponding touch panel is T2 and the time length required for sensing a single line of the corresponding touch panel is T2, wherein T2<T1.

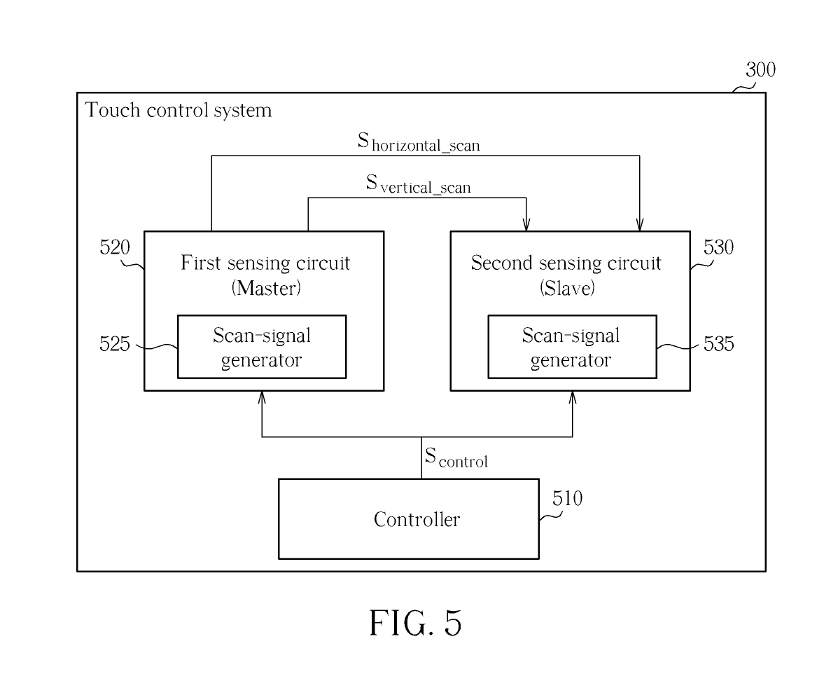

Please refer to FIG. 5. FIG. 5 is a diagram illustrating another exemplary embodiment of a touch control system of the present invention. The touch control system 500 has a controller 510 and a first sensing circuit 520. The difference between the touch control system 200 and the touch control system 500 is that the touch control system 500 has an additional sensing circuit (a second sensing circuit 530). The first sensing circuit 520 includes a scan-signal generator 525 and the second sensing circuit 30 has a scan-signal generator 535 wherein the hardware circuit of the scan-signal generators 525 and 535 can be the same. Illustratively, the controller 510 can set the scan-signal generator 525 inside the first sensing circuit 520 as a master (i.e., transmitting terminal) for generating the vertical scan control signal S_{vertcial}_{_{—}}_{scan} and the horizontal scan control signal S_{horizontal}_{_{—}}_{scan} and transmitting the generated scan control signal to the second sensing circuit 530. Compared to the first sensing circuit 520, the second sensing circuit 530 works as a slave sensing circuit and executing scan operation with the first sensing circuit 520 according to the scan timing setting determined by the vertical scan control signal S_{vertical}_{_{—}}_{scan} and the horizontal scan control signal S_{horizontal}_{_{—}}_{scan.} That is, the touch control system 500 uses both of the first sensing circuit 520 and the second sensing circuit 530 to execute a scan operation upon the corresponding touch panel (not shown) according to the same scan timing setting determined by the scan control signals.

In this way, the controller 510 can adjust/set the timing of the vertical scan control signal S_{vertical}_{_{—}}_{scan} and the horizontal scan control signal S_{horizontal}_{_{—}}_{scan} through the control signal S_{control} such as controlling the length of T1 and T2 (FIG. 4). However, the aforementioned descriptions are for illustrative purposes only and not meant to be a limitation of the present invention. For instance, the touch control system can have more sensing circuit(s) and set one of the sensing circuits as the scan-signal generating terminal and set the remaining sensing circuit(s) as the scan-signal receiving terminal and let the controller be aware of the scan timing setting via the vertical/horizontal scan control signals. In another exemplary embodiment, the controller 510 can choose the second sensing circuit 530 as the scan-signal generating terminal, and set the remaining sensing circuit(s), e.g., the first sensing circuit 520 as the scan-signal receiving terminal.

In this way, the controller of the touch control system of the present invention is no longer requested to generate the vertical scan control signal S_{vertical}_{_{—}}_{scan} and the horizontal scan control signal S_{horizontal}_{_{—}}_{scan} while still being capable of acknowledging the sensing timing of the sensing circuit(s) via the vertical scan control signal S_{vertical}_{_{—}}_{scan} and the horizontal scan control signal S_{horizontal}_{_{—}}_{scan}.

In conclusion, one of the objects of the present invention is using one of the sensing circuits (touch ICs) as the generating terminal of the vertical scan control signal S_{vertical}_{_{—}}_{scan} and the horizontal scan control signal S_{horizontal}_{_{—}}_{scan} conventionally generated by the controller, to thereby ease the burden of the controller and further shorten the sensing timing of the vertical scan control signal S_{vertical}_{_{—}}_{scan. All alternative designs obey and fall within the scope of the present invention.}

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch control system for controlling a touch panel, comprising:
a controller, for generating and outputting a control signal; and
a first sensing circuit, coupled to the controller and to sensing lines of the touch panel, for receiving the control signal from the controller, and generating at least one scan control signal according to the received control signal to determine a scan timing setting.

2. The touch control system of claim 1, wherein the first sensing circuit executes a scan operation upon the touch panel according to the scan timing setting determined by the at least one scan control signal.

3. The touch control system of claim 1, wherein the first sensing circuit is a touch controller integrated circuit (touch controller IC), and the controller is a micro-controller unit (MCU).

4. The touch control system of claim 1, wherein the first sensing circuit comprises a scan-signal generator for generating a plurality of scan control signals including a vertical scan control signal and a horizontal scan control signal; and the scan-signal generator determines a timing and a length of each of the vertical scan signal and the horizontal scan signal.

5. The touch control system of claim 1, wherein the first sensing circuit serves as a master sensing circuit, and the touch control system further comprises:
a second sensing circuit, coupled to the controller and the first sensing circuit, being a slave sensing circuit for receiving the at least one scan control signal generated from the master sensing circuit and operating according to the scan timing setting determined by the at least one scan control signal.

6. The touch control system of claim 5, wherein each of the first sensing circuit and the second sensing circuit executes a scan operation upon the touch panel according to the same scan timing setting determined by the at least one scan control signal.

7. The touch control system of claim 5, wherein each of the first sensing circuit and the second sensing circuit is a touch controller integrated circuit (touch controller IC), and the controller is a micro-controller unit (MCU).

8. The touch control system of claim 1, wherein the controller is aware of the scan timing setting via the at least one scan control signal generated from the first sensing circuit.

9. The touch control system of claim 4, wherein the vertical scan control signal corresponds to a scan time setting which controls the required time for scanning a frame of a touch panel, and the horizontal scan control signal corresponds to a scan time setting which determines the required time for scanning a scan line of the touch panel.
